(19) United States
(12) Patent Application Publication
(10) Pub. No.: US 2003/0152033 A1
(43) Pub. Date: Aug. 14, 2003

(54) Method and portable device for determining the effectiveness of radio communications in a wireless lan

(76) Inventor: Justin Howard, Cambridge (GB)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/257,069

(22) PCT Filed: Apr. 11, 2001
(86) PCT No.: PCT/EP01/04158

(30) Foreign Application Priority Data
Apr. 13, 2000 (GB) 0009084.5

(51) Int. Cl. H04L 12/28

(52) U.S. Cl. 370/245; 370/338

(57) ABSTRACT

The invention provides a method of determining the effectiveness of radio communication over an area covered by a wireless LAN. A value of a signal parameter, such as stability or throughput, is detected at each of a plurality of sample points spaced over the area. The variation in the parameter over the area is shown in colour on a display.

### FIELD OF THE INVENTION

This invention relates to wireless LANs (local area networks) and in particular to the determination of the effectiveness of radio communication over an area covered by a wireless LAN.

### BACKGROUND TO THE INVENTION

When a building is equipped with a wireless LAN, the effectiveness of radio coverage can vary from area to area within the building. The invention aims to provide a way of determining the effectiveness of radio communication over an area covered by a wireless LAN, so that areas of poor or unacceptable signal levels can be identified. These areas can then be avoided as sites for wireless LAN equipment (such as computers), or steps can be taken to improve signal quality in those areas.

### SUMMARY OF THE INVENTION

According to one aspect of the invention there is provided a method of determining the effectiveness of radio communication over an area covered by a wireless LAN, comprising detecting a value of a signal parameter at each of a plurality of sample points spaced over the area, representing the area on a display and showing on the display a representation of the variation of the parameter by interpolation between the detected values, whereby the viewer of the display can determine the effectiveness of radio communication over said area.

According to another aspect of the invention there is provided a method of illustrating the effectiveness of radio communication over an area covered by a wireless LAN, comprising detecting a value of a signal parameter at each of a plurality of sample points spaced over the area, representing the area on a display and showing on the display a representation of the variation of the parameter by interpolation between the detected values.

Preferably, the representation is by colour and in a preferred embodiment the colour green is used to show good radio communication and the colour red is used to show poor radio communication, the transition from red to green on the display being through a gradation of hues representative of the interpolation.

The interpolation may be linear or may be by any gradient fill algorithm. Conveniently, the signal parameter is throughput of data or signal stability, the latter being representative of the variation of throughput from an average value over a predetermined time, such as two seconds.

### BRIEF DESCRIPTION OF THE DRAWINGS

The invention will now be further described, by way of example, with reference to the accompanying drawings, in which:

FIG. 1 is a block diagram showing a site survey tool linked by radio to a LAN, for performing a method according to the invention,

FIGS. 2 to 4 illustrate three possible presentations shown on a display of the site survey tool of FIG. 1.

### DETAILED DESCRIPTION

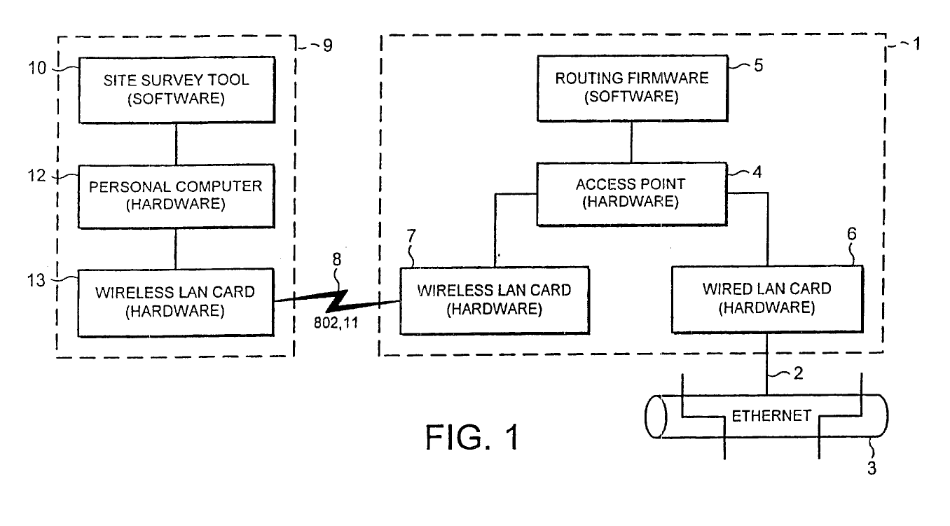

When a building is equipped with a wireless LAN, computers within the building communicate by radio with access points of the LAN, the access points being distributed over the area of radio coverage. In FIG. 1, an access point 1 of a LAN is connected by hard wiring 2 to the remainder 3 of the LAN. At the access point 1, there is hardware 4, routing or bridging firmware 5, a wired LAN card 6 (hardware) at the interface with the remainder 3 of the LAN and a wireless LAN card 7 (hardware) at the radio interface 8 with portable computers. In FIG. 1, a sample area of a building covered by the wireless LAN is being surveyed, so the access point 1 is in radio communication with a portable computer in the form of a site survey tool 9 having software 10, a personal computer 12 including a display unit and a wireless LAN card 13 (hardware) at the radio interface 8. It will be appreciated that this radio interface 8 provides two-way transmission of data between the site survey tool 9 and the access point 1 of the LAN.

By the use of the site survey tool 9, the quality of radio coverage over a sample area of the building can be detected and shown as a visual presentation on the display unit of the site survey tool 9, and also on a display unit of any other computer linked to the LAN.

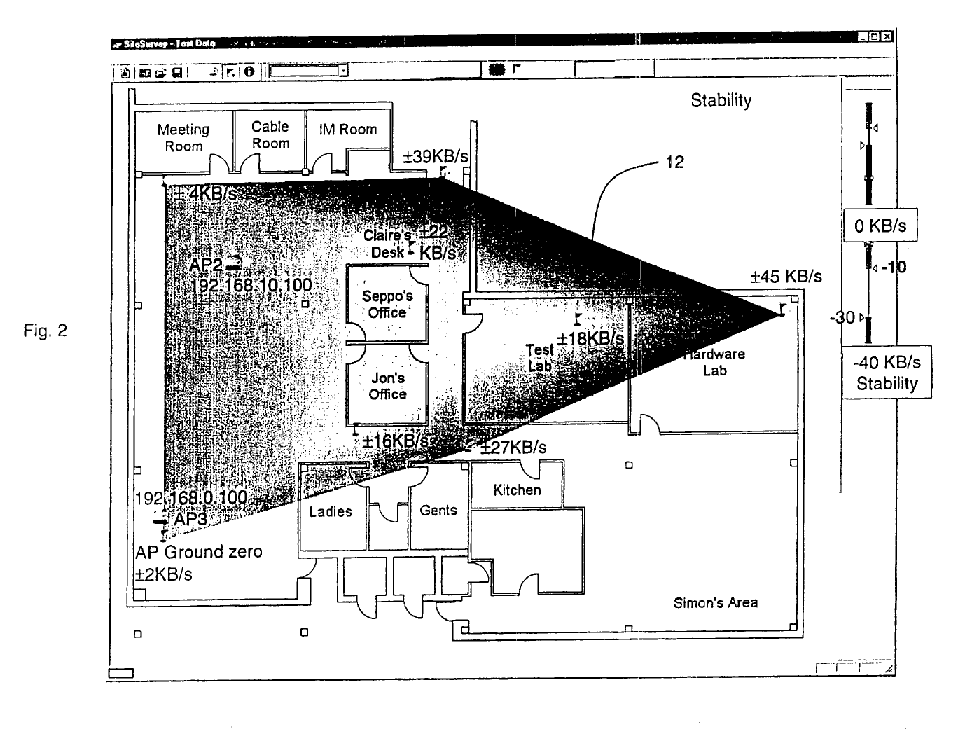

Referring to FIGS. 2, 3 and 4, suppose the area of the building to be surveyed is that within the polygonal shape whose outline is indicated at 12. The outline shape is defined by straight lines drawn between five sample points, and additional sample points are located within the area. The sample points are shown by the flag symbols in FIGS. 2 to 4. A map of the area to be surveyed is entered into the site survey tool software, typically being loaded into the site survey tool 9 from another computer linked to the access point 1. The locations of the sample points are then loaded into the site survey tool software. The site survey tool is then taken to each sample point in turn and a signal parameter is measured at each sample point. In the described method, two parameters are measured and recorded, namely signal stability and signal throughput. Stability is representative of the variation of received signal throughput from an average value. Throughput is representative of the rate of received data and is measured in bits per second. Having detected these parameters at the sample points, the software in the site survey tool is able to provide a visual representation (on the display unit of the site survey tool 9) of the variation of each parameter over the sample area. This is done by interpolation, using a gradient fill algorithm. The presentation on the display unit is in colour, green being used to show a desirable value of the parameter and red being used to show an undesirable value of the parameter, the display showing variations in intensity of green and red and showing any transition between red and green as a progressive variation in hue.

FIG. 2, which shows the variation of stability over the sample area, shows red areas as dark and green areas as light, the transition being shown as a variation of a grey colour.

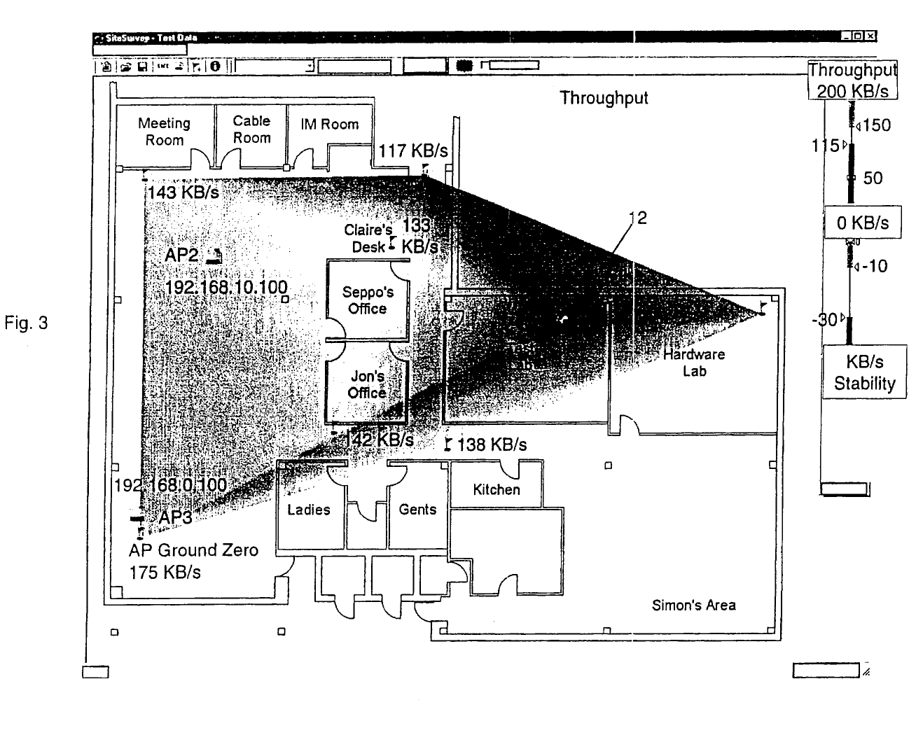

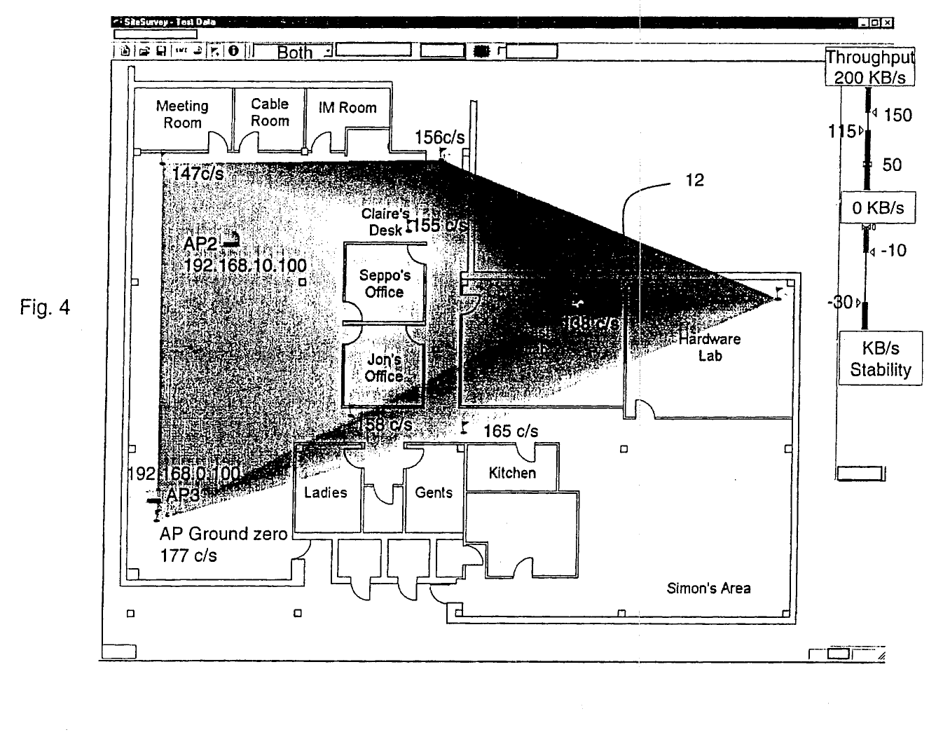

FIG. 3 shows the same area but with the illustrated parameter being throughput, and FIG. 4 shows a composite presentation where the combination of throughput and stability is represented, with each of these parameters providing a 50% weighting to the combined presentation.

1. A method of determining the effectiveness of radio communication over an area covered by a wireless LAN, comprising detecting a value of a signal parameter at each of a plurality of sample points spaced over the area, representing the area on a display and showing on the display a representation of the variation of the parameter by interpolation between the detected values, whereby the viewer of the display can determine the effectiveness of radio communication over said area.

2. A method of illustrating the effectiveness of radio communication over an area covered by a wireless LAN, comprising detecting a value of a signal parameter at each of a plurality of sample points spaced over the area, representing the area on a display and showing on the display a representation of the variation of the parameter by interpolation between the detected values.

3. A method according to claim 1 or 2, wherein the representation is by colour.

4. A method according to claim 3, wherein the colour green is used to show good radio communication and the colour red is used to show poor radio communication, the transition from red to green on the display being through a gradation of hues representative of the interpolation.

5. A method according to any of the preceding claims, wherein the interpolation is linear.

6. A method according to any of the preceding claims, wherein the signal parameter is throughput of data or signal stability, the latter being representative of the variation of received signal throughput from an average throughput.

7. A method according to any of the preceding claims, comprising detecting the values of two signal parameters at each of the plurality of sample points and showing on the display a representation of the combined variation of the two parameters.

8. A method according to claim 7, wherein the two parameters are throughput of data and signal stability.

9. A portable computer serving as a site survey tool and programmed to carry out the method of any of the preceding claims.
